(19) United States
(12) Patent Application Publication
(10) Pub. No.: US 2010/0129652 A1
(43) Pub. Date: May 27, 2010

(54) Polyethylene Films

(75) Inventor: Michael McLeod, Kemah, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/627,268

(22) Filed: Nov. 30, 2009

Related U.S. Application Data
(63) Continuation of application No. 11/830,416, filed on Jul. 30, 2007, now abandoned.
Application No. 11/830,416 is a continuation-in-part of application No. 11/774,289, filed on Jul. 6, 2007.
(60) Provisional application No. 60/830,016, filed on Jul. 11, 2006.

(51) Int. Cl. B32B 27/32; B29C 55/02

(52) U.S. Cl. 428/340; 264/291

(57) ABSTRACT

The present invention relates to polyethylene films, and to processes for making films. In particular the invention relates to solid state stretched films that may be monoaxially or biaxially oriented. The processes can tolerate high draw ratios and lower extrusion pressures and amperes while producing films having high tensile strength and modulus as well as low shrinkage. The polyethylene used to make the films has a density of from 0.940 to less than 0.960, a molecular weight distribution of greater than 10, a melt flow index ranging from 0.30 dg.min to 1.00 dg/min and a weight average molecular weight of 300,000 or less.

### FIELD

The present invention relates to polyethylene films, and to processes for making films. In particular the invention relates to solid state stretched films that may be monoaxially or biaxially oriented. The processes can tolerate high draw ratios and lower extrusion pressures and amperes while producing films having high tensile strength and modulus as well as low shrinkage.

### BACKGROUND

Processes for making solid state stretched films are well known. Generally, a polymer masterbatch is heated and then extruded, cast or blown to form a film with essentially no orientation. The film is water or air quenched thereby returning the film to a solid state. Stretching or orientation of the solid film in either one or two directions is accomplished by heating the film to a temperature at or above the glass-transition temperature of the polymer but below its crystalline melting point, and then stretching the film quickly.

Orienting the film provides a glossier and clearer film, a smoother surface, and increased tenacity. Polyethylene, particularly high density polyethylene, is particularly difficult to process in this manner. For example, a phenomenon called clubbing can occur where the stretching is uneven. It is also often difficult to obtain high draw ratios over a broad temperature range.

The prior art has proposed a number of solutions to address the difficulties experienced with solid state stretching of high density polyethylene. Examples include blending the polyethylene with a wax or with another polymer. These approaches, however, add significant production cost.

### SUMMARY

One embodiment of the invention is solid state stretched film comprising polyethylene having a density ranging from greater than 0.940 g/cc to less than 0.960 g/cc; a molecular weight distribution (Mw/Mn) 10 or greater; a melt flow index ranging from 0.30 to 1.00 dg/min; and a weight average molecular weight (Mw) of 300,000 g/mol or less.

Another embodiment is a solid state stretched film comprising a layer made from polyethylene having a density ranging from greater than 0.940 g/cc to less than 0.960 g/cc; a molecular weight distribution (Mw/Mn) 10 or greater; a melt flow index ranging from 0.30 to 1.00 dg/min; and a weight average molecular weight (Mw) of 300,000 g/mol or less.

A further embodiment is a process for producing a solid state stretched, oriented film comprising: preparing a masterbatch comprising polyethylene having a density ranging from greater than 0.940 g/cc to less than 0.960 g/cc; a molecular weight distribution (Mw/Mn) 10 or greater; a melt flow index ranging from 0.30 to 1.00 dg/min; and a weight average molecular weight (Mw) of 300,000 g/mol or less; heating and extruding the polymer melt in one direction to form a film; and then stretching the film using heat to thereby orient the film in the same direction. Optionally, the film may then be oriented in the opposite direction.

In any of these embodiments, the film may be one of a plurality of layers and/or may be laminated.

Unless specifically indicated otherwise, in any of the embodiments described herein, the film may be monoaxially or biaxially oriented.

In any of these embodiments the polyethylene molecular weight may be 250,000 g/mol or less, or 200,000 g/mol or less; the molecular weight distribution may be between 10 and 20; and the melt flow index may be between 0.20 dg/min and 0.50 dg/min.

In any of these embodiments, the film, polyethylene, or masterbatch, may be substantially free of cavitations caused by calcium carbonate, and/or substantially free of crosslinkages, and/or substantially free of wax, (including hydrocarbon and micro-crystalline wax).

Methods for making these polymers are generally well known in the art and include slurry and gas phase processes in various types of reactors, under various conditions. Ziegler-Natta catalysts and methods for their use arc well known as are metallocene and Chromium based catalysts and methods for their use.

### BRIEF DESCRIPTION OF THE DRAWINGS

FIG. 1 is a graph of complex viscosity vs. frequency for comparative vs. experimental polymer.

FIG. 2 is a graph of extruder amperes at varying throughputs (draw ratios) for comparative vs. experimental polymer.

FIG. 3 is a graph of extruder pressures at varying throughputs.

FIG. 4 is a graph of modulus at 5% elongation vs. draw ratio.

FIG. 5 is a graph of maximum tenacity vs. draw ratio.

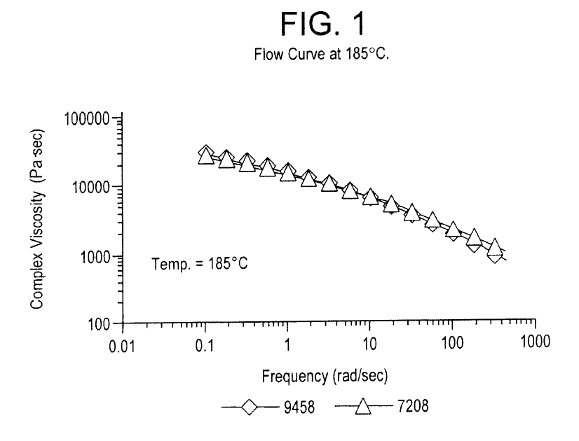

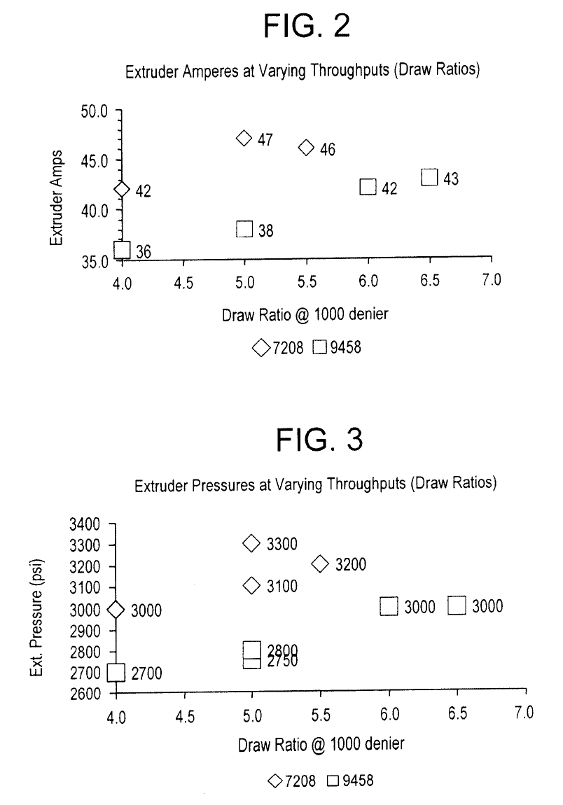

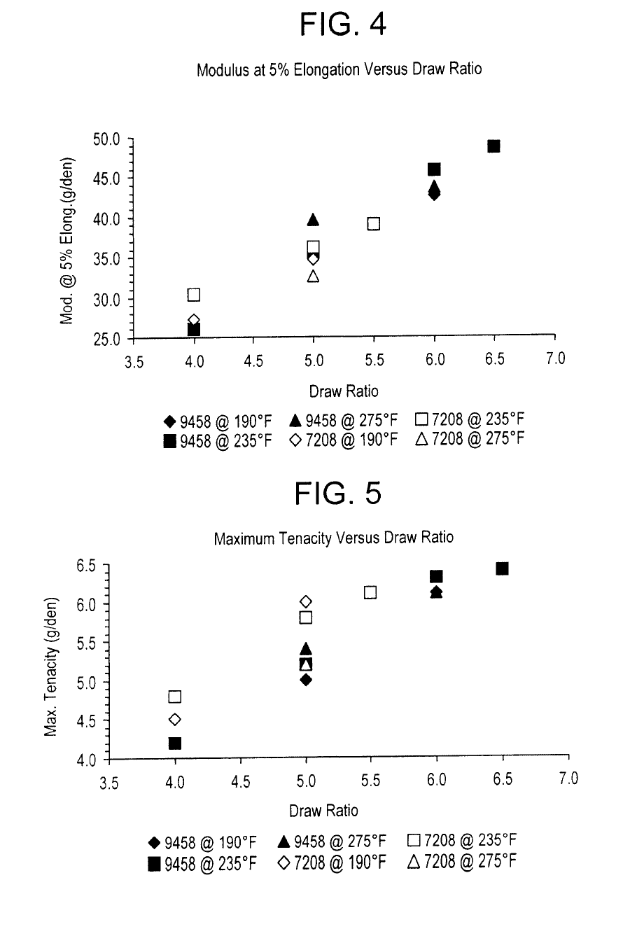

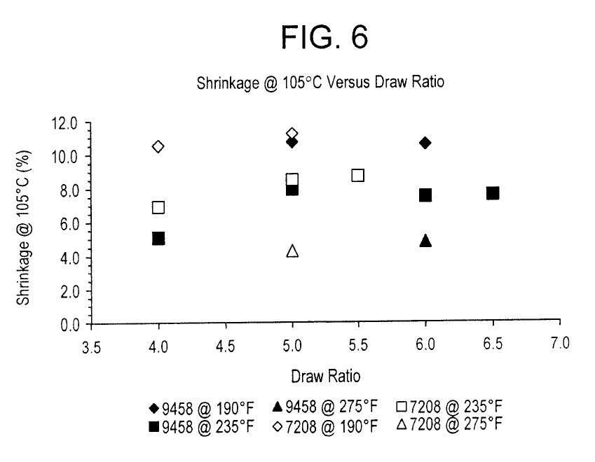

### DESCRIPTION

Embodiments of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.113 etc., and the endpoints 0 and 10. Also, a range associated with chemical substituent groups such as, for example, “C₁ to C₅ hydrocarbons,” is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Further as used in the specification and the appended claims, the singular forms “a,” “an,” and “the” include their plural referents unless the context clearly dictates otherwise. For example, references to an “extruder,” or a “polymer,” are intended to include the one or more extruders or polymers unless, otherwise stated. Likewise, reference to a composition or process containing or including “an” ingredient or “a” step is intended to include other ingredients or other steps, respectfully, in addition to the one named unless otherwise stated.

As defined herein, a “solid state stretched film”, is one that has been oriented in at least one direction subsequent to at least a quenching and a casting/extruding step. This excludes blown films.

The polyethylene described herein can be a homopolymer or copolymer containing an ethylene content of from about 90 to about 100 mol %, with the balance, if any, being made up of C₃-C₈ alpha olefins, for example. In one embodiment it is unimodal.

The polyethylene referred to herein has a density ranging from greater than 0.940 g/cc to less than 0.960 g/cc (density is determined per ASTM D792). In another embodiment, the density ranges from 0.950 to 0.960 g/cc.

The polyethylene referred to herein has a molecular weight distribution (Mw/Mn) of 10 or greater. In another embodiment the molecular weight distribution ranges from 10 to 20, or from 10 to 15 (MWD=Mw/Mn as determined by GPC).

The polyethylene described herein has a melt flow index ranging from 0.30 to 1.00 dg/min (M12: measured according to ASTM D-1238; 190° C./2.16 kg). Another embodiment includes melt flow index ranges of from 0.30 dg/min to 0.75 dg/min.

The weight average molecular weight of the polyethylene is less than 300,000, or from 300,000 to 100,000. In another embodiment, the weight average molecular weight ranges from 100,000 to 250,000, or from 100,000 to 200,000.

The polyethylene may also be compounded with one or more other additives as is prior to extrusion. These include one or more of the following non-limiting examples: antioxidants, low molecular weight resin (Mw less than about 10,000 Daltons as described in U.S. Pat. No. 6,969,740), calcium stearate, heat stabilizers, lubricants, slip/anti-block agents, mica, talc, silica, calcium carbonate, weather stabilizers, Viton GB, Viton SC, Dynamar, elastomers, fluoroelastomers, any fluoropolymers, etc.

In one embodiment, the polyethylene is substantially free of cavitations caused by calcium carbonate or any other cavitating agent, such as is described in U.S. Pat. No. 6,828,013 for example.

In another embodiment, the polyethylene (and/or subsequent film) is substantially free of crosslinkages such as is described in U.S. Pat. No. 6,241,937, for example.

In another embodiment, the polyethylene is substantially free of wax such as is described in U.S. Pat. Nos. 6,887,923, and 4,870,122, for example.

Any two or more of the above-described film-layer or film embodiments may be combined.

The films of the invention may be single or multi-layer films. For multilayered films, the additional layers may be made from any other material, for example homopolymers or copolymers such as propylene-butene copolymer, poly(butene-1), sytrene-acrylonitrile resin, acrylonitrile-butadiene-styrene resin, polypropylene, ethylene vinyl acetate resin, polyvinylchloride resin, poly(4-methyl-1-pentene), any low density polyethylene, and the like. Multilayer films of the invention may be formed using techniques and apparatus generally well known by one of the skill in the arts, such as, for example, co-extrusion, and lamination processes.

The films of this invention are particularly useful in monofilament, slit tape, and fabric applications as well as specialty film applications. Specialty film applications include biaxially oriented films and machine direction oriented (MDO) films. Such films have increased stiffness, increased strength, decreased permeability, and better optical properties (lower haze and higher gloss).

### EXAMPLES

Two polyethylenes were evaluated for their processing and properties in a solid-state stretching process, drawn tape production. One resin was 7208, a current commercial Total Petrochemicals grade that has common commercial use in solid-state stretching processes like tape and monofilament. The second product was a version of 9458 (another Total Petrochemicals commercial grade) compounded with the same additive package as 7208. Both resins were compounded in the applications lab on the same equipment. Details regarding both resins are presented in Table 1.

TABLE 1
Properties of 7208 and 9458.

Resi

| | 7208 | 9458 |
|---|---|---|
| Mn | 2019 | 1225 |
| Mw | 15606 | 17457 |
| Mz | 97168 | 116232 |
| Peak MW | 6159 | 5688 |
| Polydispersity | 7.7 | 14.3 |
| MI2 | 0.49 | 0.46 |
| HLMI | 21.1 | 34.3 |
| HLMI/MI | 43.1 | 74.6 |
| Crystallization Temp. | 117 | 117 |
| Crystallization Enthalpy | −211 | — |
| Melting Temp. | 135 | 133. |
| Melting Enthalpy | 216. | 221. |
| Density | 0.95 | 0.95 |

The tapes were processed at the same conditions. Extrusion zone temperatures were 330/330/430/450/470/470° F. moving from the extruder feedthroat to the die. The first three temperatures are the extruder barrel, the fourth is the adapter and screen pack, the fifth piping to the die and the sixth is the die temperature. Die gap was set at 15 mils. The melt was quenched in a water bath set at 100° F., with the air gap between the die exit and the water set at 0.5 inches. The quenched sheet was pulled from the water at 60 ft/min by the nip rolls and godets upstream of the oven entrance. This first group of godets was kept at ambient temperature. Solid state stretching was performed with the oven was set at three different temperatures; the temperatures were 190° F., 235° F., and 275° F. Godets after the drawing oven are combined in two discrete groups: Group #2 and Group #3. Group #2 was set at the fastest drawing speed and controlled the tape draw ratio. Group #3 was set at a speed 3% slower than Group #2 to allow some relaxation. Both groups of godets had temperatures set at 194° F. Extruder speed was adjusted at various draw ratios to maintain a 1000 denier linear density for the tapes.

One advantage of 9458 is its superior melt processing behavior. It is more shear thinning, as shown by the shear response. The shear thinning is illustrated in Error! Reference source not found., where 9458 is less viscous than 7208 at >10/sec shear rates. Extrusion improvements were noticed both in extrusion amperes and extrusion pressures. 9458 ran with lower amperes and pressures than 7208 (Error! Reference source not found. 2 and Error! Reference source not found. 3). This reduction offers the potential to extrude at higher rates for lines that are pressure or motor ampere limited.

Note that Error! Reference source not found. 2 and Error! Reference source not found. 3 are presented in terms of draw ratio. All tapes were made at a constant linear density of 1000 denier. To achieve that target density, throughput had to be increased for a given draw ratio. So draw ratio is an indirect measure of throughput. 7208 and 9458 run at the same target denier and draw ratio were being processed at the same throughput.

A second benefit 9458 offers is higher draw ratios (Table 2). Over the entire oven temperature range studied, 9458 consistently could be drawn more than 7208. This off us the potential for higher rates. Tapes are produced at a target denier. If resin can be drawn more, throughput can be raised. Raising the maximum draw ratio from 5 to 6 is equivalent to achieving a 20% increase in throughput. Such an increase is desirable for maximizing productivity.

TABLE 2
Maximum draw ratio at various drawing oven temperatures.
Tape Denier = 1000.

Resi

| | 7208 | 9458 |
|---|---|---|
| Max. DR @ 190° F. Oven | 5.0 | 6.0 |
| Max. DR @ 235° F. Oven | 5.5 | 6.5 |
| Max. DR @ 275° F. Oven | 5.0 | 6.0 |

A third benefit 9458 offers is greater stiffness (Error! Reference source not found. 4). Tape stiffness is similar between 7208 and 9458 at a given draw ratio. Since 9458 can reach higher draw ratios, it is able to produce a stiffer tape. Increased stiffness provides opportunities for downgauging in film applications. Film rigidity helps print registration, die cutting, and label dispensing. High modulus monofilament and tape helps create a stiffer woven structure.

Another benefit of 9458 is the ability to each slightly higher tenacities. The best tensile strength for 9458 was 6.4 g/denier, versus 6.1 g/denier for 7208 (Error! Reference source not found. 5). Both of these tapes were stretched at 235° F. When drawn at 275° F., 9458 reached a 6.1 g/denier tenacity while the best for 7208 was 5.2 g/denier. When stretched to their respective limits, 9458 consistently performed as well as or better than 7208.

A final benefit of 9458 is lower shrinkage (Error! Reference source not found. 5). At 190° F., the highest draw ratio 7208 had 11.2% shrinkage while the highest draw ratio 9458 was at 10.7%. At 235° C. 7208 was at 8.7% while 9458 was 7.6%. The trend was only broken at 275° F. The highest draw ratio 7208 shrank at 4.3% while 9458 shrank at 4.8%. The general trend is that 9458 would shrink less than 7208, even when 9458 was stretched to a higher draw ratio.

A surprising result is that 9458 provides lower shrinkage even though it has more high molecular weight species. This behavior can be attributed to melting behavior. Although they have the same density, 9458 has a broader melting endotherm shifted to slightly lower temperatures. This combination is thought to contribute to having lower shrinkage in oriented structures such as tape.

What is claimed is:

1. A solid state stretched film comprising polyethylene having a density ranging from greater than 0.940 g/cc to less than 0.960 g/cc; a molecular weight distribution (Mw/Mn) 10 or greater; a melt flow index ranging from 0.30 dg/min to 1.00 dg/min; and a weight average molecular weight (Mw) of 300,000 g/mol or less.

2. The film of claim 1, wherein said polyethylene is disposed in one of a plurality of layers.

3. The film of claim 1, wherein the film is monoaxially oriented.

4. The film of claim 1, wherein the polyethylene molecular weight is 250,000 g/mol or less.

5. The film of claim 1, wherein the polyethylene molecular weight is 200,000 g/mol or less.

6. The film of claim 1, wherein the polyethylene molecular weight distribution is between 10 and 20.

7. The film of claim 1, wherein the polyethylene melt flow index is between 0.20 dg/min and 0.50 dg/min.

8. The film of claim 1, wherein the polyethylene is substantially free of cavitations caused by calcium carbonate.

9. The film of claim 1, wherein the polyethylene is substantially free of crosslinkages.

10. The film of claim 1, wherein the polyethylene is substantially free of hydrocarbon wax.

11. A solid state stretched film comprising a layer made from polyethylene having a density ranging from greater than 0.940 g/cc to less than 0.960 g/cc; a molecular weight distribution (Mw/Mn) 10 or greater; a melt flow index ranging from 0.30 dg/min to 1.00 dg/min; and a weight average molecular weight (Mw) of 300,000 g/mol or less.

12. The film of claim 11, wherein the film is biaxially oriented.

13. The film of claim 11, wherein the film is monoaxially oriented.

14. The film of claim 11, wherein the polyethylene molecular weight is 250,000 g/mol or less.

15. The film of claim 11, wherein the polyethylene molecular Weight is 200,000 g/mol or less.

16. The film of claim 11, wherein the polyethylene molecular weight distribution is between 10 and 20.

17. The film of claim 11, wherein the polyethylene melt flow index is between 0.20 dg/min and 0.50 dg/min.

18. The film of claim 11, wherein the polyethylene layer is substantially free of cavitations caused by calcium carbonate.

19. The film of claim 11, wherein the polyethylene layer is substantially free of crosslinkages.

20. The film of claim 11, wherein the polyethylene is substantially free of hydrocarbon wax.

21. A tape or filament prepared from the film of claim 1.

22. A tape or filament prepared from the film of claim 11.

23. A process for producing a solid state stretched, oriented film comprising:
preparing a masterbatch comprising polyethylene having a density ranging from greater than 0.940 g/cc to less than 0.960 g/cc; a molecular weight distribution (Mw/Mn) 10 or greater; a melt flow index ranging from 0.30 dg/min to 1.00 dg/min; and a weight average molecular weight (Mw) of 300,000 g/mol or less;
heating and extruding the polymer melt in one direction to form a film; and then stretching the film using heat to thereby orient the film in the same direction.

24. The process of claim 23, wherein the film comprises two or more layers.

25. The process of claim 23 further comprising orienting the film in the opposite direction thereby obtaining a biaxially oriented film.

26. The process of claim 23, wherein the polyethylene molecular weight is 250,000 g/mol or less.

27. The process of claim 23, wherein the polyethylene molecular weight is 200,000 g/mol or less.

28. The process of claim 23, wherein the polyethylene molecular weight distribution is between 10 and 20.

29. The process of claim 23, wherein the polyethylene melt flow index is between 0.20 dg/min and 0.50 dg/min.

30. The process of claim 23, wherein the masterbatch is substantially free of calcium carbonate.

31. The process of claim 23, wherein the masterbatch is substantially free of polymerizable monomer.

32. The process of claim 23, wherein the masterbatch is substantially free of hydrocarbon wax.
